(19) United States
(12) Patent Application Publication
(10) Pub. No.: US 2014/0051045 A1
(43) Pub. Date: Feb. 20, 2014

(54) Method and Device for Enhancing Memory

(71) Applicants: James Tanner Stults, Sarasota, FL (US); Larry Wilcox Stults, Sarasota, FL (US)

(72) Inventors: James Tanner Stults, Sarasota, FL (US); Larry Wilcox Stults, Sarasota, FL (US)

(21) Appl. No.: 13/964,468

(22) Filed: Aug. 12, 2013

Related U.S. Application Data
(60) Provisional application No. 61/683,201, filed on Aug. 14, 2012.

(51) Int. Cl. G09B 19/00

(52) U.S. Cl. CPC G09B 19/00
USPC 434/236

(57) ABSTRACT

Memory enhancement and recall, particularly with respect to declarative memory, uses olfactory stimulants during memory formation, preferably during memory consolidation, and optionally during memory recall. An apparatus has a reservoir (205) for containing an olfactory stimulant (202), a dispenser (210) for releasing the stimulant, and a controller (215) for activating the dispenser. The controller may respond to user input device (220) or a sensor (225) to trigger the dispenser. An optional display (230) may provide information to the user and allow the user to provide input instead of, or in addition to, the user input device. An optional personal reservoir also allows the user to release the olfactory stimulant upon demand.

### CROSS-REFERENCE TO RELATED APPLICATION

This application claims the priority of U.S. Provisional Patent Application No. 61/683,201, filed Aug. 14, 2012, the entire disclosure and contents of which are hereby incorporated by reference herein.

### BACKGROUND

From time immemorial humans have struggled with imperfect memory. Memory enhancing supplements have been around for ages, such as ginkgo-biloba, a plant extract used by our early ancestors and by people today, which purportedly improves memory. More recently, fish oil has been touted to achieve the same end. There is little credible evidence, however, to support claims that extracts and supplements such as these confer any significant memory benefit.

Memory research today continues to seek to unlock the mysteries of memory and to better understand the underlying mechanisms of memory formation (initial creation of a memory or memories) and memory consolidation (reinforcing a memory or memories). For humans, the main olfactory system detects volatile chemicals, and the accessory olfactory system detects fluid-phase chemicals. Olfaction is a form of chemoreception. The chemicals themselves that activate the olfactory system, in general, at very low concentrations, are called odorants. Recently, Bjöorn Rasch, Christian Büchel, Steffen Gais, Jan Born, in “Odor Cues During Slow-Wave Sleep Prompt Declarative Memory Consolidation”, Science 9 Mar. 2007: Vol. 315, no. 5817, pp. 1426-1429, DOI: 10.1126/science. 1138581, hereby incorporated in its entirety by reference herein to the fullest extent permitted by applicable law, demonstrated that an olfactory stimulant, applied at the appropriate times, e.g., during memory formation and again during memory consolidation, can significantly enhance declarative memory.

### SUMMARY

Enhancing or stimulating memory formation and/or recall includes stimulating the olfactory senses one or more times during a learning process for targeted information, optionally, but preferably, stimulating the olfactory senses one or more times during a subsequent sleep, and optionally, but preferably, stimulating the olfactory senses upon awakening and/or upon re-initiation of at least part of the learning process for the targeted material. Olfactory stimulation may be accomplished automatically, manually, or both. Recall of the targeted material may be enhanced by stimulating the olfactory senses.

An apparatus for such olfactory stimulation includes a reservoir for storage of an olfactory stimulant, a dispenser to release the olfactory stimulant, and, optionally, a controller for automatically activating the dispenser in response to a predetermined event, or to release the olfactory stimulant in response to an action by a user. A personal reservoir also allows the user to release the olfactory stimulant when desired.

### BRIEF DESCRIPTION OF THE DRAWING

FIGS. 1A and 1B are an illustration of an exemplary process for enhancing the memory of a user.

FIG. 2 is a diagram of an exemplary device for enhancing the memory of a user.

FIG. 3 illustrates some exemplary personal reservoirs.

FIG. 4 illustrates an exemplary architecture for a controller capable of performing the functionality disclosed herein for memory enhancement.

### DETAILED DESCRIPTION

Definitions. The definitions provided below are for the purpose of helping the reader to understand the disclosure herein and are not intended to be limiting.

Assimilation is the process of learning by sensing targeted information in order to create a memory. Assimilation may be via sight (e.g., reading words, images, etc.), sound (listening to spoken words, music, sounds, etc.), touch (e.g., tactile responses resulting from feeling or touching a surface, or detecting heat or pressure or fluids, etc.), taste (e.g., sampling food or drinks, or flavored substances, etc.) and/or smell (e.g., inhaling and exhaling air-borne scents, fragrances, odorants or other compositions that react with olfactory receptor neurons to create an olfactory sensation).

Declarative memory is one of the two types of long-term human memory, the other being procedural (non-declarative) memory. Declarative memory refers to memories that can be consciously recalled, such as facts and knowledge, and is sometimes referred to as explicit memory.

Hippocampus-dependent brain functions are those brain functions that rely on the hippocampal region of the human brain, more particularly, the brain functions of memory formation and memory consolidation.

Memory is the mental capacity or faculty of retaining and retrieving facts, events, impressions, etc., or of recalling or recognizing previous experiences.

Memory consolidation is the reinforcing of a previously formed memory or series of memories. More specifically, memory consolidation is a category of processes that stabilize a memory trace, which is the hypothetical structural alteration in brain cells following learning, after the initial assimilation of targeted information. In more general terms memory consolidation helps convert short-term memories acquired during a learning process into long-term memories.

Memory enhancement is the improvement of a person's retention and/or recall of a memory or memories, particularly hippocampus-dependent declarative memory or memories.

Memory formation is the initial creation of a memory or series of memories in the brain.

An olfactory stimulant is an odorant. More generally, an odorant is any volatile small molecule, non-volatile protein, or non-volatile hydrocarbon capable of producing an olfactory sensation. Optionally, a plurality of odorants may be combined to create a scent or fragrance. Additionally, an olfactory stimulant, as used herein, may further comprise, or be included with, a composition, base, matrix, substance, liquid, gel, gas, solid, and the like, or a plurality thereof, to provide a foundation or carrier for the olfactory stimulant.

Targeted information is information which the person selects to assimilate to form a memory and, subsequently, to consolidate in memory. Targeted information may be, for example, text, images, graphics, facts, sounds, video, touch, taste, sights, or in any form perceivable by a person's senses. Targeted information may include a plurality of information for forming a plurality of memories.

A person who wants to enhance his or her memory of targeted information: (1) stimulates his or her olfactory senses with a desired olfactory stimulant during selected memory formation; and (2) sleeps after memory formation, during which time his or her olfactory senses are re-stimulated with the olfactory stimulant, particularly during the slow wave sleep (SWS) phase of the sleep cycle. Optionally, upon awakening, upon re-initiating at least part of the selected memory formation, or upon demand, the person can subsequently again stimulate his or her olfactory system with the olfactory stimulant to enhance memorization or recall of the targeted information.

One method for enhancing memory in a person who desires to improve his or her ability to remember one or more memories, particularly declarative memories, includes delivering an olfactory stimulant to the user during assimilation of targeted information by the user, or approximately at the same time of assimilation of targeted information by the user; and subsequently, during a next sleep by the user, automatically delivering the olfactory stimulant to the user again.

More preferably the person is re-exposed to the olfactory stimulant during a slow wave sleep phase, or phases, of his or her sleep. Still more preferably, the olfactory stimulant is delivered to the person within 60 minutes of assimilation of the targeted information, more preferably within 30 minutes, more preferably within 15 minutes, and more preferably within 5 minutes. Even more preferably, the person is exposed to the olfactory stimulant one or more times during the assimilation.

The olfactory stimulant may be released from the device a plurality of times. More preferably, the plurality of releases of the olfactory stimulant occurs at regular intervals. More preferably still, the regular intervals of olfactory stimulant releases are determined by the person desiring to enhance his or her memory, for example by setting, programming, or selecting a timer. Optionally, release of the olfactory stimulant may be controlled by a signal received from a device that monitors the person's physical state, preferably a sleep monitor.

Also, the person may, after performing the method set forth above, further expose himself/herself again to the olfactory stimulant, so as to aid in the recall of the target information. For example, during a test or presentation, or other situation wherein the person wants to better recollect the targeted information, the person may again smell the olfactory stimulant to help recall the targeted information they desire to remember. For example, the person may use the user input device to trigger release of the olfactory stimulant, or may scratch, squeeze, apply, etc., or otherwise use a personal reservoir to release the olfactory stimulant.

A method for enhancing memory therefore includes causing an odorant to be released in proximity to a person who is in the process of assimilating target information, or who recently assimilated target information, such that the person is exposed to the odorant, that is, the odorant is sensed (smelled) by the person, and/or causing the odorant to be released in proximity to the person during the person's next sleep period so that the person is again exposed to the odorant. The odorant may be released a plurality of times. The releases of the odorant may be at regular intervals if desired. When the person desires to recall the target information, the person optionally exposes himself/herself to the odorant by releasing the odorant.

A device as described herein may include: an olfactory stimulant as discussed above, the physical phase of the olfactory stimulant being at least one of solid, liquid or gaseous; a reservoir suitable for holding the olfactory stimulant; an olfactory stimulant dispenser; and a controller, including but not limited to, a user-activated switch, a signal receiver, or a sleep-monitor. The dispenser releases at least some of the olfactory stimulant responsive to receiving a signal from the controller. Optimally, the device releases the olfactory stimulant in the proximity of the user during the slow wave sleep phase of the user's sleep cycle.

Generally the device comprises an olfactory stimulant reservoir, and an olfactory stimulant dispenser. Preferably, the reservoir is at least one of refillable, replaceable, or one of a plurality of interchangeable reservoirs, thereby allowing the user to select a desired olfactory stimulant for a particular use or to suit the user's personal preferences. Optionally, the reservoir is replaceable and/or refillable and the user can fill or refill the reservoir, for example by inserting an aerosol canister, a liquid, a powder, a matrix or any other suitable olfactory stimulant. The olfactory stimulant reservoir is suitable for holding the desired olfactory stimulant. An olfactory stimulant may have a solid, liquid, or gaseous physical state.

Release of olfactory stimulant from the device may be accomplished via any of the various emitting, delivering or releasing mechanisms which are known in the art. Examples include, but are not limited to, mechanical plunger-type mechanisms and roller ball applicators for liquids, gels, sols, emulsions or flowable composition, compressible containers that can be squeezed to eject or deliver a flowable composition, screw drive and spring-loaded dispensers for solids, semi-solids, gels, etc., including waxy compositions, containers having one or more controllable orifices that normally are in the closed position, but which can be selectively opened, manually or automatically, to permit the release of compressed air or compressed gas or the gas phase of high vapor pressure (volatile) liquid from the container. A liquid, gel, cream, emulsion, or similar flowable composition is sprayed, squirted, ejected or otherwise delivered from the device. Similarly, in the case of air-borne odorants, for example, compressed air or compressed gas or gas-phase of a high vapor pressure liquid (e.g., a liquid comprising a volatile solvent such as ethanol or ether, etc.), an air-borne stimulant is released from the container into the air in the proximity of the device. Delivery or release of an olfactory stimulant into the environment in proximity to a user may be accomplished by heating, aerosolization, vaporizing, misting, atomizing, deliquescence, sublimation, ejecting of a liquid, forced air movement, dispersion, a roller ball applicator, a screw-drive lipstick style applicator, etc. Thus, the dispenser may cause the olfactory stimulant to change its physical state, such as by heating solid until it becomes a liquid, or heating a liquid until it becomes a gas. Also, the olfactory stimulant may be stored in the reservoir in any convenient form such as, but not limited to, a solid, gel, emulsion, suspension, colloid, water-based solution, volatile solvent-based solution, gas, or compressed gas.

The user of the device, at the user's discretion, activates the device to cause the release of the olfactory stimulant into the environment in proximity to the user such that the user senses the olfactory stimulant. Generally, the user will activate the device during assimilation of the targeted information and, later, when the user wishes to recall the targeted information. Release of the olfactory stimulant during assimilation of the targeted material may also be automatic.

A personal reservoir may be any scent emitting item that a user could wave under his/her nose and/or apply while studying, for example, a scented lip balm applicator, or a highlighter pen with scented ink. In this simple form the personal reservoir may be purchased already containing the olfactory stimulant. Alternatively, the personal reservoir may be purchased without the olfactory stimulant, and has a volume that can be filled (e.g., with a liquid olfactory stimulant), or has a cavity that accepts a container (e.g., aerosol can) or an insert (e.g., a waxy element) that contains the scent.

A memory formation device is a device, apparatus, composition or structure that contains and selectively releases an olfactory stimulant into the environment in proximity of a person. The device includes a reservoir of an olfactory stimulant. The olfactory stimulant may be released automatically upon the occurrence of one or more predetermined conditions or events. Additionally, or alternatively, the olfactory stimulant may be released upon demand by the user, such as by the user pressing a button, clicking on a mouse, etc., or by the user scratching a surface, breaking a capsule, applying the olfactory stimulant, etc. Examples of this device include, but are not limited to: a passive odorant releasing composition, matrix or olfactory stimulant-containing source, such as but not limited to scratch and sniff compositions or matrices, lip balms, waxes, plastics and other suitable matrices that are impregnated with odorant, and vessels, dropper bottles or other suitable containers holding liquid-based or gel-based odorants, pens and highlighters containing an olfactory stimulant in the ink or separately in a olfactory stimulant reservoir, atomizers and misting devices (e.g., perfume dispensers), spring-loaded delivery systems, lipstick/Chapstick™/lip balm style applicators containing olfactory stimulant(s) in a waxy, solid, semi-solid, or gel substance, liquid dispensers (e.g. cologne dispensers and roller ball applicators). One skilled in the art will understand that, in addition to those listed above, there are a wide variety of devices, structures and/or compositions that can be used as devices. Such devices may contain more than one olfactory stimulant, and the plural olfactory stimulants may be in different forms, such as but not limited to, aerosols, gases, and powders. Preferably, but not necessarily, at least one form of the device is easily portable by a user so that, for example, the user can release the olfactory stimulant during a test.

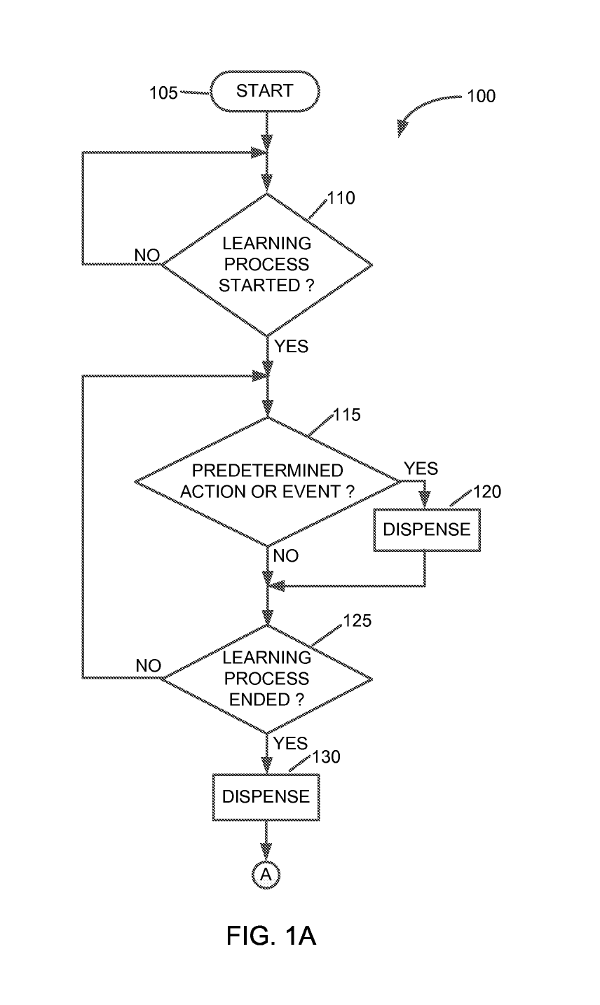

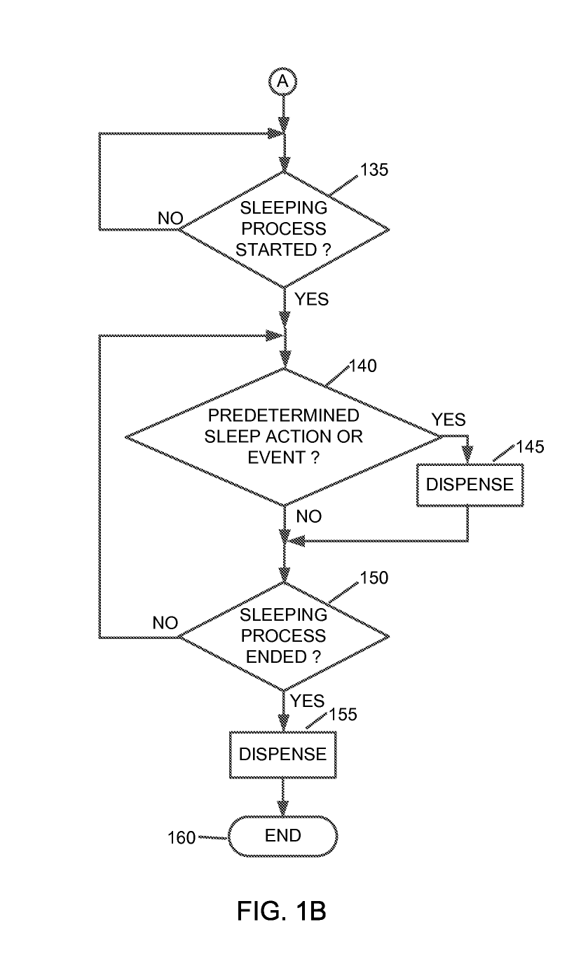

FIGS. 1A and 1B are an illustration of an exemplary process 100 for enhancing the memory of a user. Upon starting 105, at operation 110 a determination is made whether the learning process has been started. The start of the learning process may be signified by various methods, such as, but not limited to, the user pressing a button, flipping a switch, clicking on a mouse, opening (or re-opening) an electronic book (“e-book”), or opening an e-book to a particular page, or to the last page viewed, etc. If not, a return is made to wait for a signal indicating that the learning process has been started. At operation 115, a determination is made whether a predetermined action or event has occurred. That action or event may be, for example and not by way of limitation, a user toggling a switch from a first position to a second position, the user clicking on a mouse, the amount of time elapsing since the beginning of the learning process, the amount of time elapsing since the olfactory stimulant was last dispensed, the time of day, the page in the e-book, some combination of one or more of those factors, etc. If the predetermined action or event has occurred then the olfactory stimulant is dispensed 120. The olfactory stimulant may be dispensed one or more times when the predetermined action or event is detected.

After operation 115 or operation 120, at operation 125 a determination is made whether the learning process has ended. The end of the learning process may be signified by various methods, such as those mentioned above for signifying the start of the learning process, or their opposites, such as toggling the switch back to the first position, closing the e-book, etc. If the learning process has not ended then a return is made to operation 115. If the learning process has ended then, optionally, at operation 130, the olfactory stimulant is dispensed again, and may optionally be dispensed more than once. Optionally, during the learning process the user may manually initiate olfactory stimulation, such as by manually releasing, or manually causing a device to release, an olfactory stimulant. Thus, during the learning or assimilation process, that is, when the user is reading, reviewing, listening to, etc., the material to be learned, the olfactory stimulant is dispensed one or more times.

At operation 135 a determination is made as to whether the sleeping process has started. This may be signified by various methods, such as, but not limited to, the user pressing a button, toggling a switch, clicking on a mouse, closing an e-book, turning off a reading light or a room light, or by automatic methods, such as by detecting that the ambient room lighting has substantially decreased or been extinguished, by measuring the elapsed time since the user has ended the learning process, by an indication that slow wave sleep has begun. If the sleeping process has not started then a return is made to operation 135 to wait for an indication that the sleep process has started.

If the sleeping process has started then, at operation 140, a determination is made as to whether a predetermined action or event occurs while the user is sleeping. Preferably, but not necessarily, the predetermined event is that the user has entered the slow wave sleep process. The predetermined action or event may, however, simply be the elapsed time since the user has ended the learning process, the elapsed time since the ambient room lighting was reduced, the time of day, etc. If the predetermined action or event has occurred then the olfactory stimulant is dispensed one or more times at operation 145.

If a predetermined action or event has not occurred at operation 140, or if the olfactory stimulant has been dispensed at operation 145, then a determination is made at operation 150 as to whether the sleeping process has ended. The end of the sleeping process may be signified by various methods, such as those mentioned above for signifying the start of the sleeping process, or their opposites, such as the ambient room lighting being increased, the e-book being opened, detection that the slow wave sleep phase has ended, etc. If the sleeping process has not ended then a return is made to operation 140. If the sleeping process has ended then, optionally, the olfactory stimulant is dispensed again one or more times at operation 155, and then the process is ended 160. Optionally, the user may choose to further enhance the memory retention by reading, hearing, etc., the target material again so that operations 115-130 are repeated.

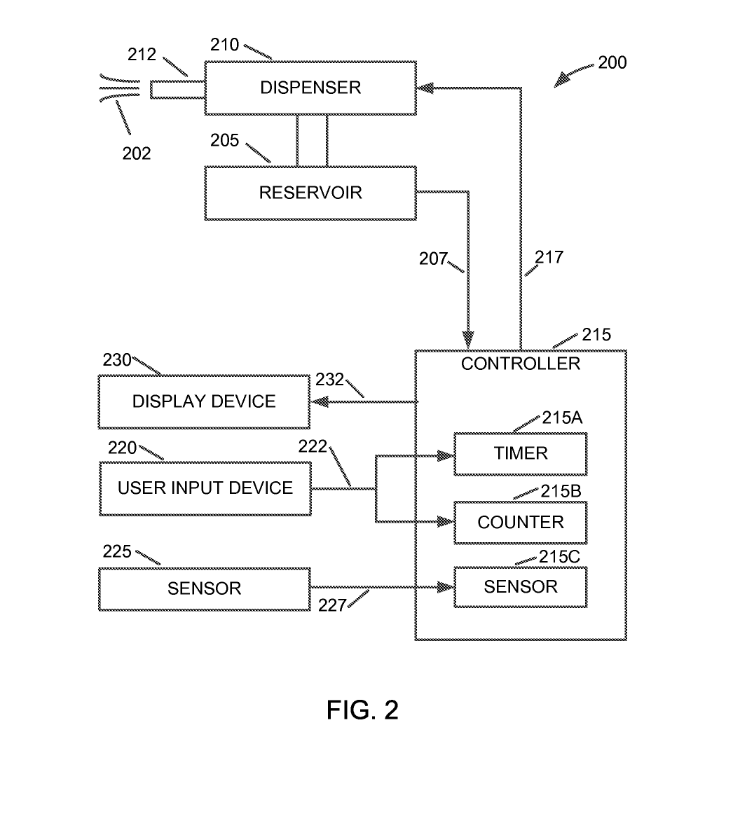

FIG. 2 is a diagram of an exemplary device 200 for enhancing the memory of a user. A reservoir 205 contains an olfactory stimulant 202. The reservoir 205 may have a olfactory stimulant level sensor (not shown) to provide an olfactory stimulant level signal 207 indicative of the amount of olfactory stimulant in the reservoir, and/or to provide an olfactory stimulant level signal 207 which simply indicates that the reservoir 205 is empty. A dispenser 210, connected to the reservoir 205, selectively dispenses the olfactory stimulant 202. The olfactory stimulant is preferably in the form of a liquid which can be atomized by the dispenser 210, a powder which can be blown by the dispenser 210, or a gas which can be selectively released by the dispenser 210. The dispenser 210 may have nozzle 212 or other device which allows the user to control the direction in which the olfactory stimulant is released.

A controller 215 may be, or include, a processor having a memory, with the memory containing operating instructions for the processor. The controller 215 may also contain circuitry which provides, or can be programmed to provide, a timer 215A, a counter 215B, and/or a slow wave sleep phase monitor sensor function 215C. The controller 215 may also just be a simple timer, a simple counter, or both. In response to control signals from a user input device 220 or a sensor 225, the controller 215 selectively provides a control signal 217 which activates the dispenser 210.

The user input device 220 allows a user to provide user input signals 222 to the controller 215. The user input device 220 may be, for example, and not by way of limitation, a switch, a pushbutton, a keypad, a keyboard, a mouse, a touch-sensitive screen (preferably integrated with the display 230), etc. In response to an appropriate user input signal 222, such as, but not limited to, the user pressing a switch or button 220 one more times, or some other signal, such as but not limited to a number pressed on a keyboard, clicking on a mouse, or a selection made on the user display 230, the controller may, for example, activate the dispenser 210 one or more times. User input signals may signify, for example, that the user is beginning the learning process, the user is ending the learning process, the user is beginning the sleep process, the user has ended the sleep process, the user desires that the olfactory stimulant be dispensed now, the user's selection of timing and frequency of release of the olfactory stimulant, which olfactory stimulant should be released, etc.

An optional sleep monitoring device or sensor 225 may monitor the state of the user and provide an output signal 227 indicative of the state of the user. Alternatively, the sleep monitoring device or sensor may provide information or data which can be used by the controller 215 to detect or predict the state of the user or one or more phases of the user's sleep cycle. The sleep monitoring device or sensor 225 therefore provides for the release of the olfactory stimulant or stimulants in the proximity of the user at the appropriate time or phase of sleep. Thus, the sleep monitor or sensor provides for a determination of the state of the user, for example, that the user is in, or is about to be in, the slow wave sleep phase.

The optional sleep monitoring device or sensor 225 may be any device which is capable of monitoring or timing a person's sleep cycle. Sleep monitoring devices and sensors 225 include, but are not limited to, smartphones with sleep monitoring applications, wristband sleep monitoring devices, electrode-based sleep monitors, gyrometers, accelerometers, heart rate monitors, optical monitors with motion analysis capabilities, motion detectors, timers, temperature sensors, and combinations of two or more of the above. In one embodiment the sleep monitoring device or sensor 225 is connected to the controller 215 and the controller 215 triggers the dispenser 210 based upon information from device or sensor 225. In another embodiment the sleep monitoring device or sensor 225 is connected directly to the dispenser 210 and can directly trigger the dispenser 210 to release the olfactory stimulant 202.

The controller 215 may be responsive to the olfactory stimulant level signal 207 to alert a user that the reservoir 205 should be refilled, and/or to discontinue activating the dispenser 210 until the reservoir 205 has been refilled. An alert may be provided to the user by the controller 215 sending a signal 232 to a display 230. The display 230 may alert the user by any convenient and desired signal perceivable by the user such as, but not limited to, text on the screen, a symbol on the screen, a light, a flashing light, a sound, an intermittent sound, a repeating sound, a vibration, the release of a different olfactory stimulant, etc.

The dispenser 210, the controller 215, user input device 220, the display 230, and the optional sleep monitoring device or sensor 225 may be wired or wireless devices, as desired.

Thus, consider now one example of operation of the device 200. The user (not shown) is ready to begin a learning process. The user activates the device 200 using the user input device 220, such as, but not limited to, pressing a button, toggling a switch, pressing a predetermined character on a keypad or keyboard, touching a “start” symbol on a display screen 230, positioning and clicking on a mouse, etc. The controller 215, in response to the user input may then activate the dispenser 210 so that it dispenses a predetermined amount of the olfactory stimulant. At predetermined times during the learning process, and/or upon demand by the user, such as by using the input device 220, the controller 215 may activate the dispenser 210 so that it dispenses a predetermined amount of the olfactory stimulant. If the user input device 220 and the display 230 are integrated, such as but not limited to, a touch-screen or an e-book, then the controller 215 may activate the dispenser 210 so that it dispenses a predetermined amount of the olfactory stimulant when the user turns a page, or every other time that the user turns a page, or when the user turns a predetermined number of pages, or when the user goes back one or more pages, etc. A predetermined amount may be the same as, or different from, an amount previously dispensed.

When the user has decided to end the learning process, such as when the user is becoming tired or the user has completed studying the relevant course materials, then the user can use the input device 220 to send an appropriate signal 222 to the controller 215. In response, and/or at one more times after the signal 222, the controller 215 may activate the dispenser 210 so that it dispenses a predetermined amount of the olfactory stimulant. Further, the olfactory stimulant may be dispensed if the user falls asleep during the learning process, such as by detecting that the user has stopped turning pages in the e-book, stopped pressing a button or clicking a mouse, etc. Thus, the olfactory stimulant may be automatically dispensed when the user is asleep after a learning process.

Furthermore, the device or sensor 225 may be, or may include, a slow wave sleep sensor which sends a signal 227 to the controller 215 to indicate that the user has entered, or is about to enter, or is leaving, or has left, the slow wave sleep mode. Alternatively, the device or sensor 225 may monitor the user and send signals 227 to the controller 215, which processes the signals 227 using software 215C to indicate that the user has entered, or is about to enter, or is leaving, or has left, the slow wave sleep mode. The controller 215 may then, at one or more predetermined times while the user is in the slow wave sleep mode, activate the dispenser 210 so that it dispenses a predetermined amount of the olfactory stimulant.

When the user awakens, which may be detected by the device or sensor 225 or signified by the user via the user input device 220, the controller 215 may then activate the dispenser 210 so that it dispenses a predetermined amount of the olfactory stimulant. Thus, the device 200 may dispense the olfactory to the user one or more times during the learning process and/or the sleeping process.

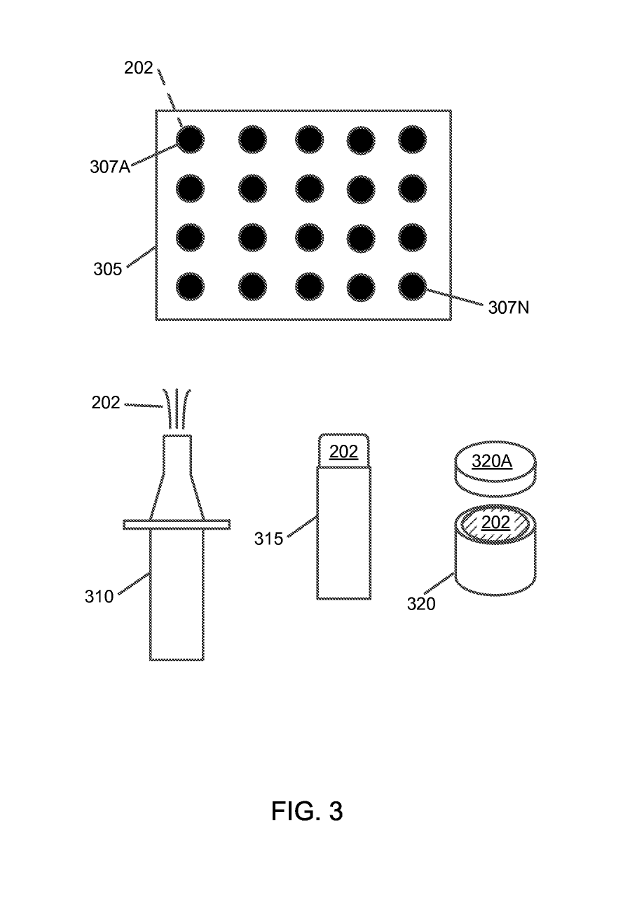

FIG. 3 illustrates some exemplary personal reservoirs 305, 310, 315, 320. Preferably, the user also has one or more portable or personal reservoirs 205 which dispense the olfactory stimulant when activated by the user. The personal reservoir 205 may be activated by, for example, scratching or breaking a reservoir 307A on a package 305 of reservoirs 307A-307N containing stimulant 202 to release the stimulant, squeezing an aerosol-mist applicator 310 to dispense the stimulant 202, moving a reservoir 315 over the user's lips to apply the stimulant 202, opening or removing a lid 320A on a container 320 containing the stimulant 202, etc., so that the olfactory stimulant is released, in some form, in the proximity of the user. Thus, the waxy of other component enclosing the olfactory stimulant 202 might be considered to be the reservoir, and the tube may be considered to be the dispenser. Similarly, the body of the container 20 might be considered to be the container or reservoir, and the lid 320A might be considered to be the dispenser which releases the olfactory stimulant. Other examples of personal containers with associated and/or integral dispensers are described herein.

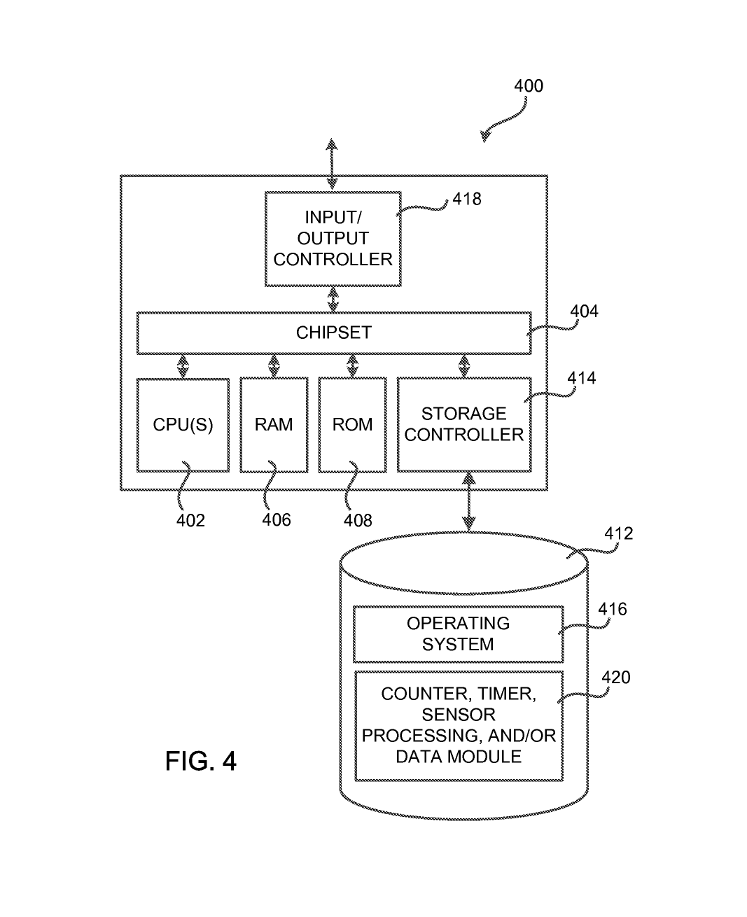

FIG. 4 illustrates an exemplary architecture for a controller 215 capable of performing the functionality disclosed herein for memory enhancement. The architecture shown for the controller 215 illustrates a conventional desktop computer, laptop computer, or other computing device, and may be utilized to execute any aspects of the software components presented herein described as executing within the computing device and/or other computing devices mentioned herein.

The computer 400 includes a baseboard, or “motherboard,” which is a printed circuit board to which a multitude of components or devices may be connected by way of a system bus or other electrical communication paths. In one illustrative embodiment, one or more central processing units (“CPUs”) 402 operate in conjunction with a chipset 404. The CPUs 402 are standard programmable processors that perform arithmetic and logical operations necessary for the operation of the computer 400.

The CPUs 402 perform the necessary operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units and the like.

The chipset 404 provides an interface between the CPUs 402 and the remainder of the components and devices on the baseboard. The chipset 404 may provide an interface to a random access memory (“RAM”) 406, used as the main memory in the computer 400. The chipset 404 may further provide an interface to a computer-readable storage medium such as a read-only memory (“ROM”) 408 or non-volatile RAM (“NVRAM”) for storing basic routines that that help to startup the computer 400 and to transfer information between the various components and devices. The ROM 408 or NVRAM may also store other software components necessary for the operation of the computer 400 in accordance with the embodiments described herein.

The chipset 404 may include functionality for providing connectivity to other devices through an input/output (“I/O”) controller 418 which may control one or more I/O ports. Not shown, but which may be present, is a network interface card which is also capable of connecting the computer 400 to other devices and computing devices over a network.

The computer 400 may be connected to a mass storage device 412 that provides non-volatile storage for the computer. The mass storage device 412 may store system programs, application programs, other program modules and data. The mass storage device 412 may be connected to the computer 400 through a storage controller 414 connected to the chipset 404. The mass storage device 412 may consist of one or more physical storage units. The storage controller 414 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 400 may store data on the mass storage device 412 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 412 is characterized as primary or secondary storage and the like.

For example, the computer 400 may store information to the mass storage device 412 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 400 may further read information from the mass storage device 412 by detecting the physical states or characteristics of one or more particular locations within the physical storage units.

In addition to the mass storage device 412 described above, the computer 400 may have access to other computer-readable storage medium to store and retrieve information, such as program modules, data structures, or other data. Computer-readable storage media is, or includes, an apparatus or composition or matter, and can be any available media that provides for the storage of non-transitory data and that may be accessed by the computer 400. For purposes of the claims, however, computer-readable storage media excludes signals and waves, per se.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 412 may store an operating system 416 utilized to control the operation of the computer 400. According to one embodiment, the operating system includes a member of the LINUX family of operating systems. According to another embodiment, the operating system includes a member of the WINDOWS® SERVER family of operating systems from MICROSOFT Corporation in Redmond, Wash. According to further embodiments, the operating system may include a member of the UNIX or SOLARIS families of operating systems. It should be appreciated that other operating systems may also be utilized. The mass storage device 412 may store other system or application programs, modules, and/or data 420 utilized by the computer 400 such: a module that functions as a counter to, for example, count the number of times that the olfactory stimulant has been released; a module that functions as a timer that measures the time since a last event, for example, the time since the sleep mode was begun; and/or a module which analyzes signals from sensor 225 to determine whether the user is in the slow wave sleep phase.

In one embodiment, the mass storage device 412 or other computer-readable storage media is encoded with computer-executable instructions that, when loaded into the computer 400, transform the computer from a general-purpose computing system into a special-purpose computer capable of implementing the embodiments described herein. These computer-executable instructions transform the computer 400 by specifying how the CPUs 402 transition between states, as described above. According to one embodiment, the computer 400 has access to computer-readable storage media storing computer-executable instructions which, when executed by the computer 400, perform aspects of one or more of the methods or procedures described herein.

The input/output controller 418 may receive and process input from a number of input devices, such as a keyboard, a mouse, a touchpad, a touch screen, an electronic stylus, or other type of user input device 220. Similarly, the input/output controller 418 may provide output to a dispenser 210, a display 230, such as a computer monitor, a flat-panel display, a touch screen, a digital projector, a printer, a plotter, or other type of output device. It will be appreciated that the computer 400 may not include all of the components shown herein, may include other components that are not explicitly shown herein, or may utilize an architecture completely different than that shown herein.

Thus, a device has been disclosed which enables a person to accomplish/execute the memory enhancement method described herein.

If wireless, the sensor 225 and the controller 215 preferably communicate using Bluetooth™ technology (or any suitable near field communication system) for the communication of the signal 227. The signal 227 may also be communicated using infrared or other technology.

Also, memory retention and/or recall may be accomplished by providing a reservoir configured to store an odorant, providing a dispenser, coupled to or integral with the reservoir, which can be caused to at least one of dispense, release or expose at least some of the odorant; and providing instructions, along with the reservoir and the dispenser, the instructions being to cause the dispenser to at least one of dispense, release or expose at least some of the odorant during at least one of the following times: (i) a learning process is beginning, (ii) a predetermined event has occurred during a learning process, (iii) a learning process has ended, (iv) a sleep cycle is beginning, or (v) a sleep cycle is ending. Optionally, an apparatus may be provided which automatically dispenses the odorant during a slow wave sleep phase. Optionally, a quantity of an odorant suitable to be installed into the reservoir may be provided.

Preferably the olfactory stimulant is musky, putrid, pungent, camphoraceous, ethereal, floral, or pepperminty. More preferably the olfactory stimulant is bitter, acrid, sweet, sour, savory, minty, or menthol. Extensive lists of scents and fragrances suitable as olfactory stimulants are well known to one skilled in the art. For example, at http://www.immuneweb.org/articles/fragrancelist.html, which is hereby incorporated by reference, a list of over 1500 chemicals that are used in the fragrance/flavors industry along with their unique CAS number is provided. Most of these chemicals come from either Aldrich's Flavors & Fragrance Catalog, hereby incorporated by reference to the fullest extent permitted by applicable law, or The Research Institute For Fragrance Materials 1992 Cross Reference List, hereby incorporated by reference to fullest extent permitted by applicable law. Chemical fact sheets, online chemical catalogs and various other industry sources, also provide information regarding such chemicals.

Odorants such as scents or fragrances or combinations thereof, suitable for use as olfactory stimulants are available commercially, for example from the Alpha Aromatics® company, Fox Chapel, Pa., including but not limited to: Acacia fragrance, Acai Berry fragrance, Agave Lime fragrance, Aldehydic fragrance, Allspice fragrance, Almond fragrance, Almond & Honey fragrance, Almond Macaroon fragrance, Aloe fragrance, Amaretto fragrance, Amber fragrance, Amber Musk fragrance, Ambergris fragrance, Ambrosia fragrance, Amish Friendship Bread fragrance, Amish Harvest fragrance, Angel Food Cake fragrance, Anise fragrance, Apple Blossom fragrance, Apple fragrance, Apple Berry fragrance, Apple Butter Pie fragrance, Apple Cider fragrance, Apple Cinnamon fragrance, Apple Crisp fragrance, Apple Jack fragrance, Apple Orchard fragrance, Apple Pear fragrance, Apple Pie fragrance, Homemade Apple Pie fragrance, Apples and Oak fragrance, Apple N Spice fragrance, Appletini fragrance, Apricot fragrance, Apricot & Cream fragrance, Apricot Freesia fragrance, Asian Pear and Lily fragrance, Asian Plum fragrance, Autumn Splendor fragrance, Autumn Time Leaf fragrance, Autumn Time Wreath fragrance, Avocado fragrance, Azalea fragrance, Baby Powder fragrance, Bacon fragrance, Baked Bread fragrance, Balsam Fir fragrance, Balsam Pine fragrance, Bamboo fragrance, Banana fragrance, Banana Cream Pie fragrance, Banana Kiwi fragrance, Banana Nut Bread fragrance, Basil fragrance, Basil Sage Mint fragrance, Bay fragrance, Bay Rum fragrance, Beragamot fragrance, Berries & Cream fragrance, Berry Blossom fragrance, Birds of Paradise fragrance, Birthday Cake fragrance, Biscotti fragrance, Biscotti, Chocolate fragrance, Blackberry Jam fragrance, Blackberry Pie fragrance, Blackberry Sage fragrance, Black Currant fragrance, Black Licorice fragrance, Black Raspberry fragrance, Blackberry Cream Vanilla fragrance, Blueberry fragrance, Blueberry Cobbler fragrance, Blueberry Flapjacks fragrance, Blueberry Muffin fragrance, Blueberry Patch fragrance, Blueberry Pie fragrance, Bouquet fragrance, Boysenberry fragrance, Bright Blossoms fragrance, Brown Sugar fragrance, Brown Sugar Dates and Fig fragrance, Brownie fragrance, Bubble Gum fragrance, Butter Cookie fragrance, Butter Pecan Pie fragrance, Butt Naked fragrance, Butter Cream fragrance, Butter Cream Crunch fragrance, Buttered Popcorn fragrance, Buttermint Candy fragrance, Butter Rum fragrance, Butterscotch fragrance, Butterscotch & Vanilla fragrance, Cabernet fragrance, Café Mocha fragrance, Cake Bake fragrance, Campfire Marshmallow fragrance, Campfire Smoke fragrance, Camphor fragrance, Candy Apple fragrance, Candied Chestnuts fragrance, Candy Cane fragrance, Candy Corn fragrance, Cannabis Flower fragrance, Cantaloupe fragrance, Cantaloupe Melon fragrance, Cappuccino fragrance, Caramel fragrance, Caramel Apple fragrance, Caribbean Coconut fragrance, Carnation fragrance, Carrot Cake fragrance, Casablanca Lily fragrance, Cashmere Bouquet fragrance, Cassia fragrance, Cassis fragrance, Cedar fragrance, Chamomile fragrance, Champagne fragrance, Champagne & Roses fragrance, Chardonnay fragrance, Cherry fragrance, Black Cherry fragrance, Cherry Blossom fragrance, Cherry Cobbler fragrance, Cherry Cheesecake fragrance, Cherry Chocolate fragrance, Cherry Crumb Pie fragrance, Red Cherry fragrance, Cheesecake fragrance, Chai Tea fragrance, Chestnuts & Brown Sugar fragrance, China Rain fragrance, Chocolate fragrance, Chocolate Chip Cookies fragrance, Chocolate Mint fragrance, Chocolate Covered Strawberries fragrance, Chocolate Mousse fragrance, Chocolate Raspberry fragrance, Chocolate Syrup fragrance, Christmas Cheer fragrance, Christmas Cookie fragrance, Christmas Memories fragrance, Christmas Splendor fragrance, Christmas Tree fragrance, Chrysanthemum fragrance, Chypre fragrance, Cilantro fragrance, Cinnamon fragrance, Cinnamon Buns fragrance, Cinnamon Cookie Dough fragrance, Cinnamon Raisin Bread fragrance, Cinnamon Red Hot fragrance, Cinnamon Stick fragrance, Cinnamon Toast fragrance, Cinnamon Toffee fragrance, Citronella fragrance, Citrus fragrance, Citrus Blast fragrance, Citrus Cilantro fragrance, Citrus Sage fragrance, Citrus Splash fragrance, Citronella fragrance, Clean Linen fragrance, Clean & Fresh fragrance, Clementine fragrance, Clove fragrance, Clover fragrance, Cocoa Butter fragrance, Cocoa Mango fragrance, Coconut fragrance, Coconut Cream Pie fragrance, Coconut, Creamy fragrance, Coconut Lime Vervain fragrance, Coco Mango fragrance, Coffee fragrance, Coffee w/Crème fragrance, Cognac fragrance, Cola fragrance, Cola, Cherry fragrance, Cola, Chocolate fragrance, Cola Rose fragrance, Cookie Dough fragrance, Cookies N Cream fragrance, Cookies for Santa fragrance, Cool Citrus Basil fragrance, Corn fragrance, Cornucopia fragrance, Cotton Candy fragrance, Country Berry Hotcakes fragrance, Country Clothesline fragrance, Country Christmas fragrance, Country Meadow fragrance, Country Spice fragrance, Crab Apple fragrance, Cran-Apple fragrance, Cran-Orange fragrance, Cranberry fragrance, Cranberry Orange fragrance, Cranberry Relish fragrance, Cranberry Spice fragrance, Cream Sorbet fragrance, Crème Brulee fragrance, Cucumber fragrance, Cucumber Mint fragrance, Cucumbers & Melons fragrance, Cupcake fragrance, Cyclamen fragrance, Daffodil fragrance, Dahlia fragrance, Daisy fragrance, Dandelion fragrance, Delphinium fragrance, Dewberry fragrance, Dirt fragrance, Dogwood fragrance, Douglas Fir fragrance, Dragon's Blood fragrance, Egg Nog fragrance, English Ivy fragrance, English Lavender fragrance, Eucalyptus fragrance, Eucalyptus Spearmint fragrance, Evergreen fragrance, Fern fragrance, Fig fragrance, Floral Bouquet fragrance, Flower Shop fragrance, Flowering Dogwood fragrance, Forest Pine fragrance, Forsythia fragrance, Frangipani fragrance, Frankincense fragrance, Frankincense & Myrrh fragrance, Freesia fragrance, French Market fragrance, Fresh Cut Grass fragrance, Fresh & Clean fragrance, Fresh Linen fragrance, Fresh Outdoors fragrance, Fresh Squeezed Orange fragrance, Frozen Margarita fragrance, Fruit Bouquet fragrance, Fruit Cocktail fragrance, Fruity Floral fragrance, Fuzzy Navel fragrance, Garden Mint fragrance, Gardenia fragrance, Gardenia Lily fragrance, Bay Rum fragrance, Georgia Peach fragrance, Geranium fragrance, German Chocolate Cake fragrance, Ginger fragrance, Ginger Blossom fragrance, Gingerbread fragrance, Gingerbread Cookie fragrance, Ginger Fig fragrance, Ginger—Hawaiian fragrance, Ginger—Kiwi fragrance, Ginger Lime fragrance, Ginger Orange fragrance, Ginger Peach fragrance, Ginger Snap fragrance, Ginger Spice fragrance, Gladiola fragrance, Goat Milk & Honey fragrance, Gooseberry fragrance, Gourmet Dark Chocolate fragrance, Graham Cracker fragrance, Grandma's Kitchen fragrance, Grape fragrance, Concord Grape fragrance, Grape Soda fragrance, Grapefruit fragrance, Grapefruit—Pink fragrance, Grapefruit—Ruby Red fragrance, Green Clover and Aloe fragrance, Green Floral fragrance, Green Mint fragrance, Green Tea fragrance, Green Tea & Cucumber fragrance, Guarana fragrance, Guava fragrance, Harvest fragrance, Hawaiian fragrance, Green Hawaiian Ginger fragrance, Hawaiian Punch fragrance, Hayride fragrance, Hazelnut fragrance, Hazelnut Coffee fragrance, Heartfelt Floral fragrance, Heather fragrance, Heliotrope fragrance, Hemlock fragrance, Herbal fragrance, Herbal Mint fragrance, Hibiscus fragrance, Holly Berry fragrance, Honey fragrance, Honey Almond fragrance, Honeydew Melon fragrance, Honeysuckle fragrance, Hot Buttered Rum fragrance, Hot Chocolate fragrance, Hot Cocoa fragrance, Hot Fudge Brownie fragrance, Hot Orange Danish fragrance, Hot Toddy fragrance, Huckleberry fragrance, Hyacinth fragrance, Hydrangea fragrance, Iced Cinnamon Rolls fragrance, Iced Pineapple fragrance, Iced Tea Twist fragrance, Impatient fragrance, Indian Sandalwood fragrance, Indian Summer fragrance, Iris fragrance, Irish Cream fragrance, Italian Biscotti fragrance, Jack's Frosty Nose fragrance, Jamaica Me Crazy fragrance, Jasmine fragrance, Jelly Beans fragrance, Jelly Doughnut fragrance, Juniper fragrance, Juniper Breeze fragrance, Just Peachy fragrance, Kailua fragrance, Kettle Corn fragrance, Key Lime Pie fragrance, Kiwi fragrance, Kiwi Strawberry fragrance, Kiwi Watermelon fragrance, Kudzu fragrance, Kumquat fragrance, Lavanda fragrance, Lavender fragrance, Lavender Apple fragrance, Lavender & Basil fragrance, Lavender Fields fragrance, Lavender Flowers fragrance, French Lavender fragrance, Lavender Sage fragrance, Lavender & Lemongrass fragrance, Lavender Martini fragrance, Leather fragrance, Lemon fragrance, Lemon Cheesecake fragrance, Lemon Chiffon fragrance, Lemon Drops fragrance, Lemon Ice fragrance, Lemon Meringue Pie fragrance, Lemon Peel fragrance, Lemon Pound Cake fragrance, Lemon Pucker fragrance, Lemon Squares fragrance, Lemon Sugar fragrance, Lemon Verbena Mint fragrance, Lemonade fragrance, Lemongrass fragrance, Lemongrass Sage fragrance, Lemon Lime fragrance, Lemon Verbena fragrance, Lick Me All Over fragrance, Licorice fragrance, Lilac fragrance, Lily fragrance, Lily of the Valley fragrance, Lime fragrance, Lime Cilantro fragrance, Linen Breeze fragrance, Log Cabin fragrance, Loganberry fragrance, Lotus Blossom fragrance, Lotus fragrance, Macadamia Nut fragrance, Madagascar Spice fragrance, Magnolia & Orange Blossom fragrance, Magnolia fragrance, Mandarin Lime fragrance, Mango fragrance, Mango Mandarin fragrance, Mango & Melon fragrance, Mango Peach fragrance, Mango Sorbet fragrance, Mango Tango Twist fragrance, Maple fragrance, Maple Fudge fragrance, Maple Pecan fragrance, Mangosteen fragrance, Maple Walnut Fudge fragrance, Marichino Cherry fragrance, Margarita fragrance, Maricopa fragrance, Marigold fragrance, Marmalade fragrance, Marshmallow fragrance, Mask Odor fragrance, Mayan Gold fragrance, Medicinal fragrance, Melon fragrance, Menthol fragrance, Merlot Wine fragrance, Midsummer fragrance, Mimosa fragrance, Mint fragrance, Mint Chocolate Chip fragrance, Mint Julep fragrance, Mistletoe fragrance, Mocha Java fragrance, Modern fragrance, Mojito fragrance, Money fragrance, Monkey Farts fragrance, Morning Glory fragrance, Moss fragrance, Mulberry fragrance, Mulberry Spice fragrance, Mulled Cider fragrance, Muscadine fragrance, Musk fragrance, Myrrh fragrance, Nag Champp fragrance, Narcissus fragrance, New Mown Hay fragrance, Neroli fragrance, Neutroleum Alpha fragrance, New Car Scent fragrance, Nutmeg fragrance, Nutty Taffy Apples fragrance, O'Christmas Tree fragrance, Oak & Apples fragrance, Oakmoss fragrance, Oatmeal Cookies fragrance, Oatmeal, Milk & Honey fragrance, Oatmeal Raisin Cookie fragrance, Ocean Breeze fragrance, Ocean Mist fragrance, Odor Mask fragrance, Odor Neutralizers fragrance, Olive Blossom fragrance, Orange fragrance, Orangesicle fragrance, Orange Blossom fragrance, Orange Burst fragrance, Orange & Cinnamon fragrance, Orange Clove fragrance, Orange Cranberry fragrance, Orange Fresh fragrance, Orange Fruit fragrance, Orange Juice fragrance, Orange Peel fragrance, Orange Sherbet fragrance, Orange Spice fragrance, Orchid fragrance, Orchid Rain fragrance, Oriental fragrance, Orris Root fragrance, Pansy fragrance, Papaya fragrance, Papaya Mango fragrance, Paper Whites fragrance, Passion Flower fragrance, Passion Fruit fragrance, Passionate Smooch fragrance, Passionflower & Acai Berry fragrance, Patchouli fragrance, Peach fragrance, Peach Blossom fragrance, Peach, Fresh fragrance, Peaches N'Cream fragrance, Peach Brandy fragrance, Peach Nectar fragrance, Peach Preserves fragrance, Peanut Butter Cookie fragrance, Peanut Butter Cup fragrance, Pear fragrance, Spiced Pear fragrance, Pearberry fragrance, Pears n'Berries fragrance, Pecan fragrance, Pecan Pie fragrance, Pecan & Pralines fragrance, Peony fragrance, Peppercorn fragrance, Peppermint fragrance, Peppermint Stick fragrance, Persimmon spice fragrance, Periwinkle fragrance, Pie Crust fragrance, Pikake Flowers fragrance, Pina Colada fragrance, Pine fragrance, Pine Forest fragrance, Pinion Pine fragrance, Pineapple fragrance, Pineapple Cilantro fragrance, Pineapple Upside Down Cake fragrance, Pink Grapefruit fragrance, Pistachio fragrance, Plum fragrance, Plum Pudding fragrance, Plumeria fragrance, Poinsettia fragrance, Pomegranate fragrance, Midnight Pomegranate fragrance, Popcorn fragrance, Poppy fragrance, Potpourri fragrance, Potpourri Spice fragrance, Powder fragrance, Primrose fragrance, Pumpkin fragrance, Pumpkin Apple Butter fragrance, Pumpkin Cheesecake fragrance, Pumpkin Crunch Cake fragrance, Pumpkin Pie fragrance, Pumpkin Pie Spice fragrance, Pumpkin Spice fragrance, Rain fragrance, Rainforest fragrance, Raspberry fragrance, Raspberry Cream fragrance, Raspberry Guava fragrance, Raspberry Sorbet fragrance, Raspberry Truffle fragrance, Red Currant fragrance, Red Currant & Thyme fragrance, Red Hot Cinnamon fragrance, Rice Flower & Shea fragrance, Ripened Raspberry fragrance, Roasted Chestnut fragrance, Root Beer fragrance, Rose fragrance, Rose Geranium fragrance, Rose Jasmine fragrance, Rosemary fragrance, Rosemary Mint fragrance, Rosewood fragrance, Rum Ripened Raisin fragrance, S'mores fragrance, Sage fragrance, Sage Leaf fragrance, Sage & Citron fragrance, Sage, Sweetgrass & Cedar fragrance, Sandalwood fragrance, Sandalwood Vanilla fragrance, Sassafras fragrance, Satin Sheets fragrance, Satsuma fragrance, Sea Breeze fragrance, Seasons Greetings fragrance, Sex on the Beach fragrance, Sinus Relief fragrance, Sleigh Bells fragrance, Sleigh Ride fragrance, Smoke Out fragrance, Snapdragon fragrance, Snicker Doodle fragrance, Spearmint fragrance, Spice fragrance, Spice Cake fragrance, Spiced Apple Pecan fragrance, Spiced Chestnut fragrance, Spiced Coffee Cake fragrance, Spiced Cranberry fragrance, Spiced Gum Drops fragrance, Spiced Sugar Plum fragrance, Spiced Tea fragrance, Spring Rain fragrance, Spruce fragrance, Strawberries-n-Cream fragrance, Strawberry fragrance, Strawberry Cheesecake fragrance, Strawberry Daiquiri fragrance, Strawberry Jam fragrance, Strawberry-Kiwi fragrance, Strawberry Patch fragrance, Strawberry Preserves fragrance, Strawberry Rhubarb Pie fragrance, Strawberry Shortcake fragrance, Strawberry Wine fragrance, Sugar Champagne fragrance, Sugar Cookie fragrance, Sugar Plum fragrance, Sun Dried Cotton fragrance, Sweet Grass fragrance, Sweet Orange Chili Pepper fragrance, Sweet Pea fragrance, Sweet Potato Pie fragrance, Syringa fragrance, Tamarind Nectarine fragrance, Tangerine fragrance, Teaberry fragrance, Tea Rose fragrance, Teakwood fragrance, Three Wise Men fragrance, Thyme fragrance, Tibetan Black Tea fragrance, Tiger Lily fragrance, Tobacco fragrance, Toffee Maple Crunch fragrance, Tomato Leaf fragrance, Tonka Bean fragrance, Tropical Delight fragrance, Tropical Paradise fragrance, Truffles fragrance, Tuberose fragrance, Tulip fragrance, Tuscan Wine fragrance, Tutti Fruitti fragrance, Twigs & Berries fragrance, Vanilla Almond fragrance, Vanilla fragrance, Vanilla Bean fragrance, Vanilla Bean Xmas fragrance, Vanilla Berry fragrance, Vanilla Blossom fragrance, Vanilla and Bourbon fragrance, Vanilla, Cherry fragrance, Cinnamon Vanilla fragrance, Coconut Vanilla fragrance, Vanilla Cream fragrance, Vanilla Extract fragrance, French Vanilla fragrance, Vanilla Grapefruit fragrance, Vanilla Hazelnut fragrance, Vanilla Musk fragrance, Nutty Vanilla fragrance, Orange Vanilla fragrance, Vanilla Spice fragrance, Vanilla Sugar fragrance, Vanilla Velvet fragrance, Verbena fragrance, Verbena & Lemon fragrance, Vetiver fragrance, Victorian Christmas fragrance, Vineyard Grape fragrance, Violet fragrance, Walnut fragrance, Warm Vanilla & Sugar fragrance, Wassail fragrance, Water Lily fragrance, Watermelon fragrance, Wedding Cake fragrance, Wedding Day fragrance, White Chocolate fragrance, White Chocolate Truffle fragrance, White Citrus fragrance, White Linen fragrance, White Tea & Ginger fragrance, White Tea fragrance, White Truffle Raspberry fragrance, Wild Flower fragrance, Wild Honeysuckle fragrance, Wild Mountain Berry fragrance, Wine Cellar fragrance, Wine & Roses fragrance, Winter Garden fragrance, Winter mint fragrance, Wintergreen fragrance, Wisteria fragrance, Witches Magical Brew fragrance, Woodberry fragrance, Xmas Wreath fragrance, Ylang Ylang fragrance, Yuzu fragrance, Zinfandel fragrance, and Zinnia fragrance.

Based on the foregoing, it should be appreciated that technologies for enhancing memory formation, consolidation and recall have been presented herein. Although some of the subject matter presented herein has been described in language specific to computer structural features, methodological acts, transformative acts, specific computing machinery, and computer readable media, it is to be understood that the appended claims are not necessarily limited to the specific features, acts, or media described herein. Rather, the specific features, acts and mediums are disclosed as exemplary forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the exemplary embodiments and applications illustrated and described, and without departing from the true spirit and scope of the present invention, which is set forth in the following claims.

1. An apparatus for improving at least one of retention or recall of a memory, the apparatus comprising:
a reservoir configured to store an odorant;
a dispenser, coupled to or integral with the reservoir, and responsive to a first control signal to cause at least some of the odorant to be dispensed;
a controller to provide the first control signal to the dispenser in response to at least one of the following events: (i) a learning process is beginning, (ii) a predetermined event has occurred during a learning process, (iii) a learning process has ended, (iv) a sleep cycle is beginning, (v) a slow wave sleep phase is beginning, or (vi) a sleep cycle is ending.

2. The apparatus of claim 1 and further comprising a sensor to monitor a state of a user, the sensor being coupled to the controller to provide information to the controller regarding the state of a user, the controller being responsive to the information to determine whether at least one of the events is present.

3. The apparatus of claim 2 wherein the sensor provides information that a slow wave sleep phase is beginning.

4. The apparatus of claim 1 and further comprising a personal reservoir, the personal reservoir being configured to store the odorant, the personal reservoir dispensing at least some of the odorant upon demand by a user.

5. The apparatus of claim 1 and further comprising a user input device to provide a second control signal, and wherein the controller is responsive to the second control signal to provide the first control signal.

6. The apparatus of claim 5 wherein the user input device is at least one of: a switch, a button, a mouse, or a touchscreen.

7. The apparatus of claim 1 and further comprising a display device to provide status information to a person.

8. The apparatus of claim 1 wherein the dispenser dispenses the odorant by at least one of heating, aerosolization, vaporizing, misting, atomizing, deliquescence, sublimation, ejecting of a liquid, forced air movement, or dispersion.

9. The apparatus of claim 1 wherein the odorant is in a form of one of: solid, gel, emulsion, suspension, colloid, water-based solution, volatile solvent-based solution, or gas.

10. The apparatus of claim 1 wherein the odorant is an olfactory stimulant.

11. The apparatus of claim 1 and further comprising a timer, and wherein the controller is responsive a second control signal from a user input device to cause the dispenser to dispense the odorant after the timer determines passage of a predetermined amount of time.

12. The apparatus of claim 1 and further comprising a sensor and a timer, the sensor being to monitor a state of a user, the sensor being coupled to the controller to provide information to the controller regarding the state of a user, the controller being responsive to the information to start the timer, and wherein the controller is responsive to the timer determining passage of a predetermined amount of time to cause the dispenser to dispense the odorant.

13. A method for improving at least one of retention or recall of a memory, the method comprising:
providing a reservoir configured to store an odorant;
providing a dispenser, coupled to or integral with the reservoir, which can be caused to at least one of dispense, release or expose at least some of the odorant; and
providing instructions, along with the reservoir and the dispenser, the instructions being to cause the dispenser to at least one of dispense, release or expose at least some of the odorant during at least one of the following times: (i) a learning process is beginning, (ii) a predetermined event has occurred during a learning process, (iii) a learning process has ended, (iv) a sleep cycle is beginning, or (v) a sleep cycle is ending.

14. The method of claim 13 and further comprising providing an apparatus which automatically dispenses the odorant during a slow wave sleep phase.

15. The method of claim 13 and further comprising providing a quantity of an odorant suitable to be installed into the reservoir.
